(19) United States
(12) Patent Application Publication
(10) Pub. No.: US 2010/0145610 A1
(43) Pub. Date: Jun. 10, 2010

(54) VIEWING DEVICE FOR AIRCRAFT COMPRISING RADIO NAVIGATION BEACON DISPLAY MEANS AND ASSOCIATED METHOD

(75) Inventors: Corinne BACABARA, Le Haillan (FR); Christian Nouvel, Merignac (FR); Jean-Noel Perbet, Eysines (FR)

Correspondence Address: LOWE HAUPTMAN HAM & BERNER, LLP, 1700 DIAGONAL ROAD, SUITE 300, ALEXANDRIA, VA, 22314, US

(73) Assignee: THALES, Neuilly Sur Seine (FR)

(21) Appl. No.: 12/542,008

(22) Filed: Aug. 17, 2009

(30) Foreign Application Priority Data
Sep. 5, 2008 (FR) 08 04887

(51) Int. Cl. G01C 21/32

(52) U.S. Cl. 701/208

(57) ABSTRACT

The general field of the invention is that of viewing systems of synthetic vision SVS type, comprising at least one navigation database, a cartographic database of a terrain, position sensors, a radio navigation beacon sensor, an electronic computer, a human-machine interface means and a display screen, the computer comprising means of processing the different information obtained from the databases, from the sensors and from the interface means, said processing means arranged so as to provide the display screen with a synthetic image of the terrain including a representation of the beacons present on said terrain. In the system according to the invention, the beacons present beyond a first distance from the system are not represented, the beacons present at a distance between said first distance and a second distance less than the first distance are represented in symbolic form, the beacons present at a distance less than the second distance are represented in physical form.

### CROSS-REFERENCE TO RELATED APPLICATIONS

The present application is based on, and claims priority from, French Application Number 08 04887, filed Sep. 5, 2008, the disclosure of which is hereby incorporated by reference herein in its entirety.

### BACKGROUND OF THE INVENTION

1. Field of the Invention

The general technical field of the invention is that of synthetic vision systems, also called SVS, used more particularly in aeronautics to show the pilot piloting- or navigation-related information in the most ergonomic manner possible. In the present case, the graphic representation concerns the display of the radio navigation beacons.

2. Description of the Prior Art

The display devices of SVS type give the pilots a better awareness of the surrounding hazards such as collisions with the ground without loss of control, commonly called CFIT standing for “Controlled Flight Into Terrain”. CFITs are the primary cause of catastrophic accidents among civil aeroplanes. The aeronautical industry focuses its efforts on means of reducing them, or even permanently eliminating them. Generally, the SVS systems display a synthetic terrain together with natural obstacles or human constructions in perspective. Thus, the pilot has the most realistic perception possible of the outside landscape. Conventionally, the SVS data are displayed on a screen commonly called PFD, standing for “Primary Flight Display”.

Obviously, the locating of the radio navigation beacons is crucial to navigation. However, it is sometimes difficult to establish the link between the radio navigation data displayed on the “navigation display” screen, the navigation data available on the aeronautical maps and the outside. This is more particularly true for aircraft flying at low altitude such as helicopters. In this case, the pilots mostly work in visual flight conditions and can fly at low altitude in an uneven relief, which sometimes masks the signal from the radio navigation beacons. It is therefore crucial for the radio navigation beacons to be able to be displayed as legibly as possible.

### SUMMARY OF THE INVENTION

The viewing device according to the invention makes it possible to represent the radio navigation beacons in a simple, legible and intuitive manner. It implements three arrangements according to the distance from the beacon to the carrier. On the one hand, when the beacon is too far away, it is not represented. Then, when it is at a medium distance, it is represented in a symbolic form and arranged so that it is visible to the pilot. Finally, at short distance, when it is in sight, the beacon is represented in its physical form.

More specifically, the subject of the invention is a viewing system of synthetic vision SVS type, comprising at least one navigation database, a cartographic database of a terrain, position sensors, a radio navigation beacon sensor, an electronic computer or processor, a human-machine interface means and a display screen, the computer comprising means of processing the different information obtained from the databases, from the sensors and processor from the interface means, said processing means arranged so as to provide the display screen with a synthetic image of the terrain including a representation of the beacons present on said terrain, characterized in that the beacons present beyond a first distance from the system are not represented, the beacons present at a distance between said first distance and a second distance less than the first distance are represented in symbolic form, the beacons present at a distance less than the second distance are represented in physical form.

Advantageously, the symbolic representation of the beacon comprises three parts, a bottom part located at the conformal placement of the position of the beacon on the terrain, a vertical junction line and a standardized symbol representing the beacon arranged above said junction line. In addition, the symbolic representation can include an indication of the transmission frequency of the beacon.

More specifically, the junction line has a size that is sufficient for the standardized symbol to dominate the surrounding terrain and not be masked by the relief. In addition, from a certain distance, the symbolic representation has an apparent display size representative of a constant size on the terrain.

Advantageously, the symbolic representation of the beacon undergoes a change of appearance according to whether the signal transmitted by the beacon is picked up or not. This change of appearance may be either a blinking, or a change of colour, or a change of line type (broken lines or solid lines).

Advantageously, the physical representation of the beacon is representative of the external appearance of the beacon.

In addition, the beacons may be represented as semi-transparent.

The invention also relates to a radio navigation beacon display method for a viewing system of synthetic vision SVS type (mounted on a carrier, said system comprising at least one navigation database, a cartographic database of a terrain, position sensors, a radio navigation beacon sensor, an electronic computer, a human-machine interface means and a display screen, the computer comprising means of processing the different information obtained from the databases, from the sensors and from the interface means, said processing means arranged so as to provide the display screen with a synthetic image of the terrain including a representation of the beacons present on said terrain, characterized in that the method comprises the following steps:

Search for the beacons present beyond a first distance from the carrier according to the databases and the position of the carrier;

Determination, for the beacons that are found, of the distance from said beacons;

For the beacons present at a distance between said first distance and a second distance less than the first distance, display of said beacons in symbolic form;

For the beacons present at a distance less than the second distance, display of said beacons in physical form.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 represents the diagram of a viewing system according to the invention;

FIGS. 2 and 3 represent the display in symbolic form of a radio navigation beacon situated at a first distance from the carrier in two different configurations;

FIG. 4 represents the radio navigation beacon symbols depicted in the legends of the aeronautical maps, these symbols being taken from the French regulations;

FIG. 5 represents the display in physical form of a radio navigation beacon situated at a second distance from the carrier;

FIG. 6 represents the flow diagram of the display method according to the invention.

### MORE DETAILED DESCRIPTION

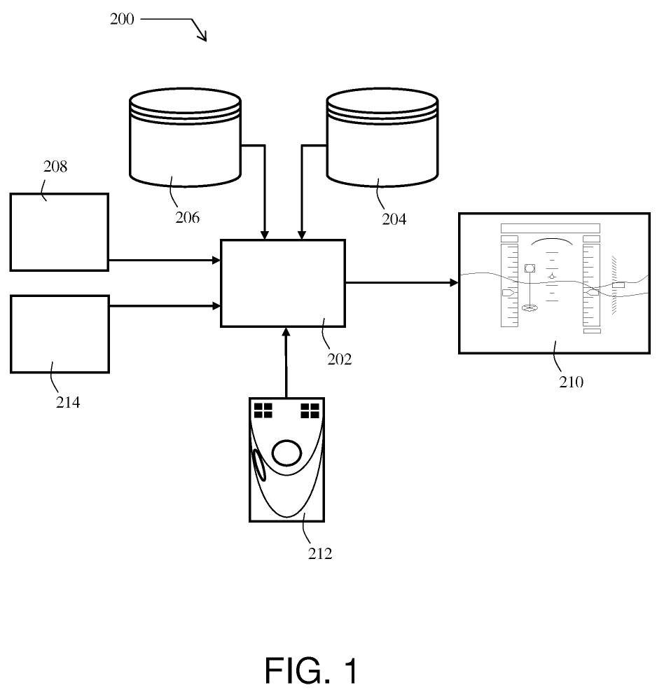

As an example, FIG. 1 represents one possible embodiment of a system according to the invention for aeronautical applications. The graphic display system 200 is installed in an aircraft and comprises a computer or a processor 202 configured to provide a viewing screen 210 with the information to be displayed.

One or more data sources are linked to the processor 202. These data sources include a first terrain database 206 used to plot the perspective view and a second navigation database 204 comprising the radio navigation beacons, such as the VOR (Very High Frequency Omnidirectional Range) beacons, DME (Distance Measuring Equipment) beacons or ADF (Automatic Direction Finder) beacons. These databases are generally positioned in the aircraft. The data can also originate from the ground via transmission means or “data link”. In addition, these data can be stored on different peripheral devices such as diskettes, hard disks, CD-ROMs, volatile memories, non-volatile memories, RAMs or any other means that can be used to store data.

The display system also comprises positioning sensors 208 and radio navigation beacon sensors 214. Human-machine interface and control means 212 complement the system. These means are, for example, as represented in FIG. 1, CCDs (Cursor Control Devices), means similar to computer “mice”. They can also be control stations, buttons, potentiometers, etc.

The processor 202 is interfaced with hardware components which provide a graphic rendition. For example, these hardware components are one or more microprocessors, memories, storage appliances, interface cards or any other standard components. In addition, the processor 202 works with software or firmware. It is capable of reading machine instructions to perform various tasks, computations and control functions and generate the signals to be displayed and the other data used by the display screen. These instructions can be stored on diskettes, hard disks, CD-ROMs, volatile memories, non-volatile memories, RAMs or any other means that can be used to store data. All these means are known to those skilled in the art.

The display screen 210 can be a cathode ray tube (CRT) screen, a liquid crystal display (LCD) screen or any other screen type. The display screen is generally an instrument panel screen. However, the display is not limited to just this type of screen. Thus, the display screen 210 can be the image source of a head-up display, known by the acronym HUD, or be part of a headset viewing optic or of night vision binoculars, JVN. This display screen 210 can also be dedicated to a system for projecting images on the windscreen.

The processor 202 supplies the data to be displayed to the display screen 210 based on the position of the aeroplane obtained from the positioning sensors 208, the terrain databases 206 and the radio navigation beacon data 204. The processor 202 is configured to receive and compute the aeroplane data, namely its latitude/longitude position, its speed, its heading, etc., from the current location of the aeroplane obtained from the positioning sensors 208 which can be, for example, an inertial unit or a GPS (Global Positioning System) type system.

Based on the position data, the processor 202 obtains the terrain data from the terrain database 206. It sends the data to the display screen 210 to represent a synthetic image.

The navigation database 204 brings together the information on the radio navigation beacons, namely their position, for example in latitude/longitude, the usage frequency or the type of the beacons (ADF, VOR, DME, etc). This database can be, for example, included in the flight management system or FMS. The processor 202 can take the data relating to the beacons from the navigation database but the data can also be directly supplied to it by the onboard instruments of the aircraft such as the FMS, or by external sources via data links or sensors.

The processor 202 analyses the data obtained from the navigation database and determines whether the radio navigation beacons are at a distance less than a selected distance d1 from the aircraft. This distance d1 is, for example, 10 NM (Nautical Miles). The radio navigation beacons that are at distances greater than this distance are not displayed. This function has the two-fold advantage of limiting the workload of the processor and of enhancing the legibility of the image by reducing the number of symbols displayed, an operation known by the expression “decluttering”, since it displays only the radio navigation beacons that are useful to the pilot of the aircraft. The selected distance d1 can be either imposed by the crew through the control means 212 or be a distance computed by the processor 202 by taking into account several criteria such as the speed of the aircraft, the size of the aircraft, the size of the screen 210 or any other criteria.

Similarly, the processor 202 chooses to display either the physical representation of the radio beacons between the aircraft and the distance d2, or the symbolic representation between d2 and the distance d1. The distance d2 can be either imposed by the crew through the control means 212 or be a distance computed by the processor 202 by taking into account a number of criteria such as the speed of the aircraft, the size of the aircraft, the size of the screen 210 or any other criteria. As an example, d2 can be 1 NM. To simplify the task of the pilot, the conformal viewing of the radio navigation beacons in this SVS system is implemented. The pilot can thus best find his bearings and navigate more easily. In addition, his workload is lightened.

The perspective view can be egocentric, that is, seen from the current position of the aircraft, or exocentric, that is, seen from a point other than the current position of the aircraft. The user can choose between these two representation modes through the control means 212. The display or not of the radio navigation beacons can be controlled from the control means 212. The control means 212 provide the pilot with the possibility of decluttering the representation on the screen if too many beacons are displayed simultaneously.

The processor 202 determines the representation of the radio navigation beacons.

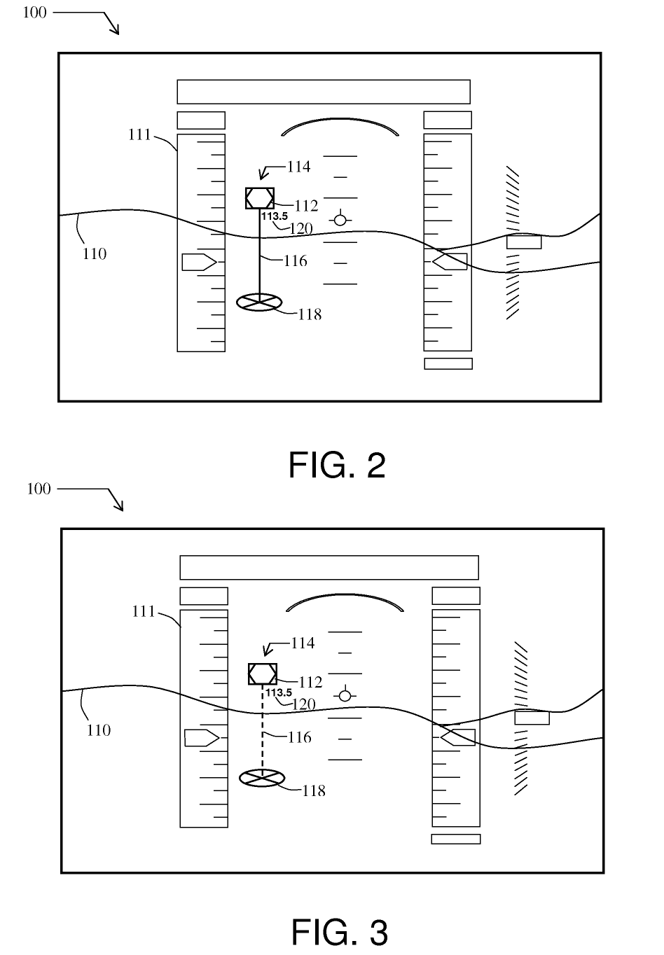

As examples, FIGS. 2, 3 and 5 represent simplified views of the images 100 displayed by a device according to the invention. In these figures, the curved lines in fine continuous lines symbolize a perspective view of the relief of the terrain 110 as seen by the pilot. These figures also include a symbology 111 of PFD (Primary Flight Display) type, essentially symbolized by graduated rectangles drawn in fine lines. Two types of representation can be envisaged: a physical representation or a symbolic representation. FIGS. 2 and 3 comprise a symbolic representation of a beacon. FIG. 5 comprises a physical representation of a radio navigation beacon. In the figures, the beacons are represented in thick lines.

In these two types of representation, the transparency of these symbols can be adjusted so as not to interfere with the reading of other symbologies such as the conventional PFD symbologies. It can be set, for example, at 50%. The default colour of these symbols is the white-grey used to plot the conventional symbology. This colour can be different, provided that compliance with the aeronautical standards is assured.

Only the beacons present between the aircraft and a first selected distance d1 are represented. This distance d1 can be either selected by the pilot, or determined by the computer according to the speed of the aircraft, its altitude, etc. It is 10 nautical miles (NM) in our example. This provides the pilot with the best awareness of the surrounding beacons, and thus makes it possible for him to determine his position more easily and obtain his visual references needed for his navigation more easily.

Between the aircraft and a second distance d2, either defined by the operator, or computed by the processor according to the altitude and the speed of the aircraft, the physical representation is used. In our example of FIG. 5, this distance d2 can be 1 NM.

Between the distance d2 and the distance d1, the symbolic representation is used. By way of examples, FIGS. 2 and 3 comprise a symbolic representation 114 of a VOR-DME-type radio navigation beacon. The symbolic representation of a radio navigation beacon according to the invention comprises three parts, a bottom part 118 located at the conformal placement of the position of the beacon on the terrain, a vertical junction line 116 and a symbol 112 representing the beacon arranged above said junction line 116.

The symbolic representation is plotted in a conformal manner on the landscape, that is to say, it is positioned at the real position of the beacon on the terrain. In addition, it is represented in perspective: the further the beacon is away from the aircraft, the smaller the symbolic representation becomes.

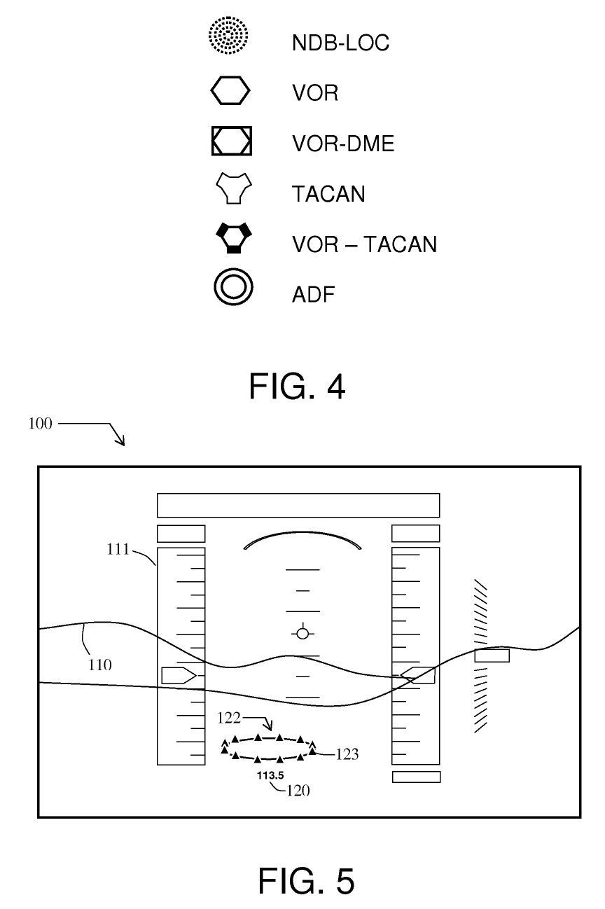

The symbols 112 can be derived either from a regulation or be freely chosen. In the latter case, the crew must be trained to recognize and interpret them. It is more beneficial to use standardized symbols that are immediately identifiable to the pilot. It should be noted that the standardized symbol is taken from a particular regulation in force in a given country. It can differ from one country to another. As an example, FIG. 4 represents certain beacon symbols 112 taken from the French regulation that can be found on the legends of the aeronautical maps. The left-hand column of FIG. 4 shows the symbols, and in line with them, in the right-hand column, the acronyms of the beacons they represent. The symbols used are given by way of example and can be entirely different for an application in another country such as the United States, the United Kingdom, etc. In the example of FIGS. 2 and 3, a VOR-DME beacon 112 is represented by a hexagon situated in a rectangle.

This top part of the symbol 114 is represented at a certain height h1 relative to the ground. This height is calculated by the processor according to the altitude and the speed of the aircraft, the surrounding terrain, etc., so that the symbol is always visible to the pilot. It is linked to the terrain by a junction line 116.

This junction line 116 can be represented with a greater or lesser line thickness. From a certain distance, the height h1 is fixed to allow a better discernment of the object and a better awareness of the perspective and the type of beacon, bearing in mind that the beacon may be concealed by the relief of the terrain. This minimum fixed height h1 is chosen according to the mission, the type of terrain, etc. In our example, this height h1 is of the order of 50 feet.

The bottom part 118 of the symbol is situated on the synthetic “ground” and is positioned according to the position of the beacon taken from the navigation databases. As an example, this can be, as represented in FIGS. 2 and 3, an ellipse provided with a central cross to best correlate the position of the beacon on the ground with its external location.

The processor 202 also uses the validity datum on receiving the signal from the radio beacon obtained from the radio navigation beacon sensors 214 to modify the symbolic representation of the beacon which undergoes a change of appearance according to whether the signal transmitted by the beacon is picked up or not. This change of appearance can be either a blinking, or a change of colour, or a change of style of the lines that make up the representation. For example, if the signal is picked up, then the junction line of the symbol of the symbolic representation is represented by continuous lines as represented in FIG. 2, otherwise it is represented in broken lines as represented in FIG. 3. This change of state provides a way of validating the correct reception of the signal obtained from the radio navigation beacon.

The value 120 of the frequency of the radio navigation beacon is displayed close to the top part of the symbol 114, preferably below and to the right of this top part. In FIGS. 2, 3 and 5, this frequency is 113.5 MHz. However, a label positioning algorithm can be applied thereto in order for this label not to conflict with, for example, the conventional symbology of the PFD. It is essential to avoid any superimposition between the conventional symbology and the indication of this frequency so as not to mislead the pilot when reading the parameters from the PFD.

If the radio navigation beacon is close to the aircraft, a physical representation 122 of the beacon is produced as illustrated in FIG. 5. This representation corresponds to the appearance of the physical beacon installed in the real world. In the example of FIG. 5, the beacon represented is of the VOR Doppler type 122. This type of beacon generally comprises twelve identical conical transmitters evenly distributed around a circumference. In FIG. 5, these transmitters are represented by triangles 123.

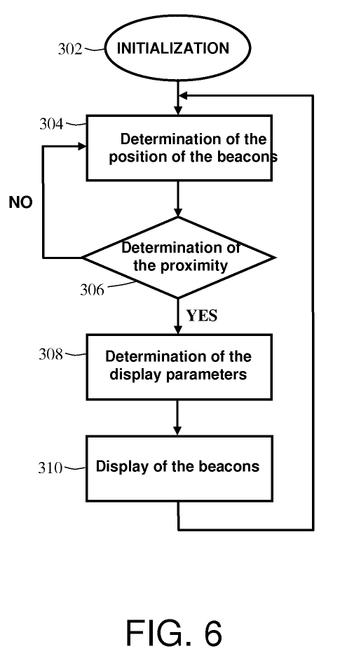

FIG. 6 is an exemplary flow diagram of the method according to the invention for displaying radio navigation beacons in perspective view. This flow diagram comprises the following steps:

Step 302: initialization of the display.

Step 304: the radio navigation beacons close to the position of the aircraft are sought. This search is carried out, for example, by using one or more processors which use the current position of the aeroplane to determine whether beacons, present in the navigation database, are within a perimeter close to the aeroplane.

Step 306: the processor determines whether the radio navigation beacons that have been found are located between the selected distance d1 and the aircraft. If the beacons that have been found are not situated in this area then the process returns to the step 302 to find other beacons. This search loop for the beacons in the desired area continues until there are beacons that fulfil this location condition. This loop is a way of avoiding cluttering the screen display. Since the user manages a large quantity of information, it is beneficial to display only the beacons that are of interest.

Step 308: by comparing the distance d from the beacon to the aircraft to the selected distance d2 which is, in our example, 1 NM,
the processor chooses the type of representation, physical if d is less than d2, symbolic otherwise.
Depending on the type of the beacon, a datum that is supplied by the navigation database, the processor determines the symbol to be displayed and its location from the position supplied by the database.
If the signal obtained from the beacon is picked up or not, then the symbolic representation differs.

Step 310: the beacons are displayed on the screen according to the position, the type, etc., determined in the preceding step. The process is repeated from the step 304. The repetition rate can be 30 times a second.

The main field of application of the system and of the method according to the invention is aeronautics. In this field, the aircraft can be a rotary or fixed wing aircraft. Obviously, the aircraft can also be a drone or unmanned air vehicle (UAV) controlled from the ground. It is also possible to use these principles for any vehicles using radio navigation beacons, such as certain land vehicles or certain ships.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalents thereof.

1. Viewing system of synthetic vision SVS type, comprising at least one navigation database, a cartographic database of a terrain, position sensors, a radio navigation beacon sensor, an electronic computer, a human-machine interface means and a display screen, the computer comprising means of processing the different information obtained from the databases, from the sensors and from the interface means, said processing means arranged so as to provide the display screen with a synthetic image of the terrain including a representation of the beacons present on said terrain, wherein the beacons present beyond a first distance from the system are not represented, the beacons present at a distance between said first distance and a second distance less than the first distance are represented in symbolic form, the beacons present at a distance less than the second distance are represented in physical form.

2. The viewing system according to claim 1, wherein the symbolic representation of the beacon comprises three parts, a bottom part located at the conformal placement of the position of the beacon on the terrain, a vertical junction line and a standardized symbol representing the beacon arranged above said junction line.

3. The viewing system according to claim 2, wherein the symbolic representation also includes an indication of the transmission frequency of the beacon.

4. The viewing system according to claim 2, wherein the junction line has a size that is sufficient for the standardized symbol to dominate the surrounding terrain and not be masked by the relief.

5. The viewing system according to claim 2, wherein, from a certain distance, the symbolic representation has an apparent display size representative of a constant size on the terrain.

6. The viewing system according to claim 2, wherein the symbolic representation of the beacon undergoes a change of appearance according to whether the signal transmitted by the beacon is picked up or not.

7. The viewing system according to claim 6, wherein the change of appearance is either a blinking, or a change of colour, or a change of line type.

8. The viewing system according to claim 1, wherein the physical representation of the beacon is representative of the external appearance of the beacon.

9. The viewing system according to claim 2, wherein the beacons are represented as semi-transparent.

10. Radio navigation beacon display method for a viewing system of synthetic vision SVS type mounted on a carrier, said system comprising at least one navigation database, a cartographic database of a terrain, position sensors, a radio navigation beacon sensor, an electronic computer, a human-machine interface means and a display screen, the computer comprising means of processing the different information obtained from the databases, from the sensors and from the interface means, said processing means arranged so as to provide the display screen with a synthetic image of the terrain including a representation of the beacons present on said terrain, characterized in that the method comprises the following steps:
search for the beacons present beyond a first distance from the carrier according to the databases and the position of the carrier;
Determination, for the beacons that are found, of the distance from said beacons;
For the beacons present at a distance between said first distance and a second distance less than the first distance, display of said beacons in symbolic form;
For the beacons present at a distance less than the second distance, display of said beacons in physical form.
